(19) United States
(12) Patent Application Publication
(10) Pub. No.: US 2020/0338827 A1
(43) Pub. Date: Oct. 29, 2020

(54) ADDITIVE MANUFACTURING APPARATUS AND MODIFICATION METHOD THEREFOR

(71) Applicant: MITSUBISHI HITACHI POWER SYSTEMS, LTD., Yokohama-shi (JP)

(72) Inventors: Shigenobu EGUCHI, Yokohama (JP); Shinya IMANO, Yokohama (JP)

(73) Assignee: MITSUBISHI HITACHI POWER SYSTEMS, LTD., Yokohama-shi, Kanagawa (JP)

(21) Appl. No.: 16/833,081

(22) Filed: Mar. 27, 2020

(30) Foreign Application Priority Data
Apr. 26, 2019 (JP) 2019-084936

(51) Int. Cl. B29C 64/268; B29C 64/245; B29C 64/295; B29C 64/393

(52) U.S. Cl. CPC B29C 64/268; B29C 64/245; B33Y 30/00; B29C 64/393; B29C 64/295

(57) ABSTRACT

An additive manufacturing apparatus makes it unnecessary to use a heater power supply, and makes it possible to attempt to reduce the cost, by effectively using an electron beam, includes: a conductive stage in a vacuum chamber; a conductive base plate on a top side of the stage; a metal-material supply device that supplies a metal material onto a top side of the base plate; an electron beam gun that irradiates, with an electron beam, the metal material supplied by the metal-material supply device, and melts and solidifies the metal material; a grounding circuit that grounds the stage and the base plate; and a controller that controls the metal-material supply device and the electron beam gun. The additive manufacturing apparatus includes a resistance heating element that is arranged between the stage and the base plate, and generates heat by a current produced by electron-beam emission from the electron beam gun.

### BACKGROUND OF THE INVENTION

### 1. Field of the Invention

The present invention relates to an additive manufacturing apparatus that performs additive manufacturing by irradiating a metal material with an electron beam, and a modification method therefor.

### 2. Description of the Related Art

Additive manufacturing apparatuses that perform additive manufacturing by irradiating a metal material with an electron beam are known. An additive manufacturing apparatus in JP-2017-530027-T includes: a stage arranged in a vacuum chamber; a base plate arranged on the top side of the stage; a metal-material supply device that supplies a wire-like metal material onto the top side of the base plate; and an electron beam gun that irradiates, with an electron beam, the metal material supplied by the metal-material supply device, and melts and solidifies the metal material. Then, metal layers are shaped sequentially to manufacture a three-dimensionally shaped manufactured object on the base plate.

An additive manufacturing apparatus in JP-2017-165998-A includes: a temperature sensor provided at the interface between a base plate and a manufactured object; a resistance heating heater arranged under a stage; and a control unit that controls ON/OFF of a current to flow through the resistance heating heater on the basis of an output of the temperature sensor.

Although not described clearly, the additive manufacturing apparatus in JP-2017-165998-A requires a heater power supply for causing a current to flow through the resistance heating heater. However, the present inventors noticed that it becomes unnecessary to use a heater power supply if an electron beam emitted from an electron beam gun is used effectively.

The present invention is made in view of the matters described above, and an object thereof is to provide an additive manufacturing apparatus that makes it unnecessary to use a heater power supply, and makes it possible to attempt to reduce the cost, by effectively using an electron beam, and a modification method therefor.

### SUMMARY OF THE INVENTION

In order to achieve the object, a representative aspect of the present invention is an additive manufacturing apparatus including: a conductive stage arranged in a vacuum chamber; a conductive base plate arranged on a top side of the stage; a metal-material supply device that supplies a metal material onto a top side of the base plate; an electron beam gun that irradiates, with an electron beam, the metal material supplied by the metal-material supply device, and melts and solidifies the metal material; a grounding circuit that grounds the stage and the base plate; and a controller that controls the metal-material supply device and the electron beam gun. The additive manufacturing apparatus includes a resistance heating element that is arranged between the stage and the base plate, and generates heat by a current produced by electron-beam emission from the electron beam gun.

According to the present invention, it is made unnecessary to use a heater power supply, and it is made possible to attempt to reduce the cost, by effectively using an electron beam.

### BRIEF DESCRIPTION OF THE DRAWINGS

FIG. 1 is a figure representing a schematic structure of an additive manufacturing apparatus in a first embodiment of the present invention; and

FIG. 2 is a figure representing a schematic structure of an additive manufacturing apparatus in a second embodiment of the present invention.

### DESCRIPTION OF THE PREFERRED EMBODIMENTS

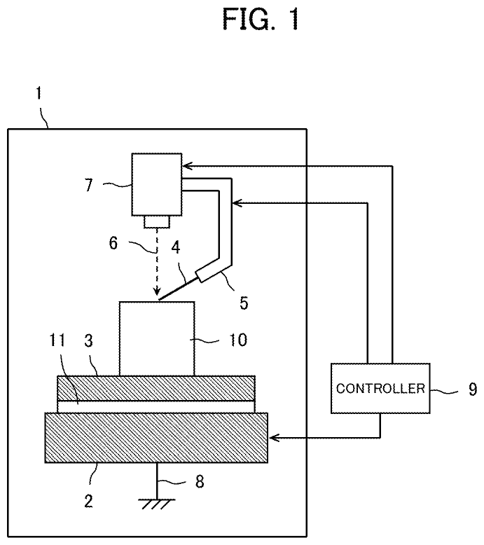

A first embodiment of the present invention is explained by using FIG. 1. FIG. 1 is a figure representing a schematic structure of an additive manufacturing apparatus in the present embodiment.

An additive manufacturing apparatus of the present embodiment includes: a conductive stage 2 arranged in a vacuum chamber 1; a conductive base plate 3 arranged on the top side of the stage 2; a metal-material supply device 5 that supplies a wire-like metal material 4 onto the top side of the base plate 3; an electron beam gun 7 that irradiates, with an electron beam 6, the metal material 4 supplied by the metal-material supply device 5, and melts and solidifies the metal material 4; a grounding circuit 8; and a controller 9.

The stage 2 is configured to be movable horizontally, and rotatable about a vertical axis. The grounding circuit 8 of the present embodiment includes a ground wire connected to the stage 2, and grounds the stage 2 and the base plate 3.

Although not illustrated, the electron beam gun 7 has a filament that generates the electron beam 6, and a focusing coil that focuses the electron beam 6. The electron beam gun 7 and the metal-material supply device 5 are coupled to each other such that an irradiation position of the electron beam 6 coincides with a supply position of the metal material 4. The electron beam gun 7 is configured to be movable horizontally and vertically, and rotatable about a horizontal axis, together with the metal-material supply device 5.

Although not illustrated, the controller 9 has a storage unit (specifically, for example, a memory, a hard disk, and the like) that stores a program and/or design data of a manufactured object, and a processor that executes a control process on the basis of the program and/or the design data of the manufactured object. The controller 9 controls a position and/or a rotation angle of the stage 2, and also controls a position and/or a rotation angle of the electron beam gun 7 and the metal-material supply device 5. In addition, the controller 9 controls ON/OFF of the emission of the electron beam 6 by the electron beam gun 7, and also controls ON/OFF of the supply of the metal material 4 by the metal-material supply device 5. Thereby, metal layers are shaped sequentially to manufacture a three-dimensionally shaped manufactured object 10 on the base plate 3.

After completion of the manufacture, the manufactured object 10 formed integrally with the base plate 3 is taken out from the vacuum chamber 1 to the outside. Note that, during the manufacture, the inner space of the vacuum chamber 1 is a high vacuum created by a vacuum pump (not illustrated). Thereby, mixing of impurities in the manufactured object 10 is prevented.

Meanwhile, in a case where a thickness of each layer of the manufactured object 10 is large, and a manufacture speed is high, and/or in a case where a high strength superalloy (specifically, for example, a high strength nickel-based alloy, a high strength cobalt-based alloy, or the like) is used as the metal material 4, a temperature of the manufactured object 10 is preferably kept high to prevent cracks of the manufactured object 10. In addition, a temperature gradient of the manufactured object 10 is preferably kept small. Explaining specifically, while a top portion of the manufactured object 10 is at a high temperature due to heat input with the electron beam 6 from the electron beam gun 7, a bottom portion of the manufactured object 10 is at a low temperature due to heat release through the base plate 3 and the stage 2. Accordingly, the bottom portion of the manufactured object 10 is preferably warmed.

In view of this, the additive manufacturing apparatus of the present embodiment includes a resistance heating element 11 (specifically, for example, one that is made of carbon, a ceramic or the like, has a resistance higher than those of the stage 2 and the base plate 3, and converts electricity into heat) that is arranged between the stage 2 and the base plate 3. Then, along with the emission of the electron beam 6 from the electron beam gun 7, electrons move through the manufactured object 10, the base plate 3, the resistance heating element 11, the stage 2, and the grounding circuit 8 in this order. With this movement of electrons (i.e., a current), the resistance heating element 11 generates heat, and can warm the base plate 3, and the bottom portion of the manufactured object 10. Thereby, the temperature of the manufactured object 10 can be kept high, and the temperature gradient of the manufactured object 10 can be kept small. Accordingly, cracks of the manufactured object 10 can be prevented. In addition, since the electron beam 6 is used effectively, it is made unnecessary to use a heater power supply for causing a current to flow through the resistance heating element 11, and it is made possible to attempt to reduce the cost.

Note that, when the additive manufacturing apparatus of the present embodiment is to be constructed, the entire apparatus may be constructed newly, but an existing additive manufacturing apparatus may be modified. That is, the resistance heating element 11 may be provided in an existing additive manufacturing apparatus. This modification can be made easily as compared to modifications in cases where heater power supplies are required.

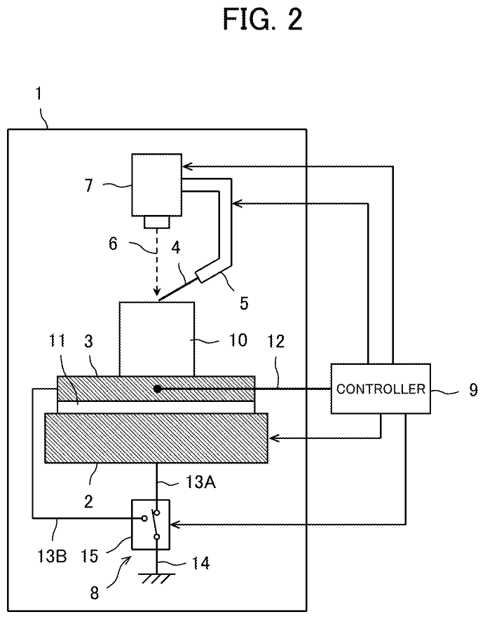

A second embodiment of the present invention is explained by using FIG. 2. FIG. 2 is a figure representing a schematic structure of an additive manufacturing apparatus in the present embodiment. Note that, in the present embodiment, portions that have counterparts in the first embodiment are given the same reference signs, and explanations thereof are omitted as appropriate.

The additive manufacturing apparatus of the present embodiment includes a temperature sensor 12 (specifically, for example, a thermocouple) that senses a temperature of the base plate 3 (in the figure, the temperature is an internal temperature of the base plate 3, but may be a surface temperature).

The grounding circuit 8 of the present embodiment includes a connection wire 13A connected to the stage 2, a connection wire 13B connected to the base plate 3, a ground wire 14, and a switch 15 that selects one of the connection wires 13A and 13B, and connects the selected one to the ground wire 14.

In addition to functions similar to those in the first embodiment, the controller 9 of the present embodiment has the function of controlling the switch 15 in accordance with the temperature of the base plate 3 sensed by the temperature sensor 12. Specifically, in a case where the temperature of the base plate 3 is lower than a preset predetermined value, the controller 9 controls the switch 15 such that the connection wire 13A and the ground wire 14 are connected. Thereby, a current flows through the manufactured object 10, the base plate 3, the resistance heating element 11, the stage 2, the connection wire 13A, and the ground wire 14, and the resistance heating element 11 generates heat. Accordingly, the base plate 3 and the bottom portion of the manufactured object 10 can be warmed.

On the other hand, in a case where the temperature of the base plate 3 sensed by the temperature sensor 12 is equal to or higher than the predetermined value, the controller 9 controls the switch 15 such that the connection wire 13B, and the ground wire 14 are connected. Thereby, a current flows through the manufactured object 10, the base plate 3, the connection wire 13B, and the ground wire 14. That is, a current does not flow through the resistance heating element 11, and the resistance heating element 11 does not generate heat.

In the present embodiment configured as described above also, similar to the first embodiment, it is made unnecessary to use a heater power supply, and it is made possible to attempt to reduce the cost, by effectively using the electron beam 6. In addition, in the present embodiment, the temperature of the base plate 3 can be adjusted.

Note that, when the additive manufacturing apparatus of the present embodiment is to be constructed, the entire apparatus may be constructed newly, but an existing additive manufacturing apparatus may be modified. Explaining specifically, the resistance heating element 11 and the temperature sensor 12 may be provided in an existing additive manufacturing apparatus. The grounding circuit 8 may include the connection wires 13A and 13B, the ground wire 14, and the switch 15. The function of controlling the switch 15 in accordance with the temperature of the base plate 3 sensed by the temperature sensor 12 may be added to the controller 9. This modification can be made easily as compared to modifications in cases where heater power supplies are required.

Note that, although not explained particularly in the first and second embodiments, before manufacture of the manufactured object 10, the controller 9 may perform control such that the base plate 3 is directly irradiated with the electron beam 6 from the electron beam gun 7, to preheat the base plate 3. In this case also, the resistance heating element 11 generates heat, thus the preheating temperature of the base plate 3 can be raised.

In addition, although in the examples explained in the first and second embodiments, the stage 2 is configured to be movable horizontally, and rotatable about a vertical axis, this is not the sole example. For example, the stage 2 may be configured to be unmovable and unrotatable. In this case, the controller 9 may not have the function of controlling the stage 2.

In addition, although in the examples explained in the first and second embodiments, the additive manufacturing apparatus includes the metal-material supply device 5 that supplies the wire-like metal material 4, this is not the sole example. The additive manufacturing apparatus may include a metal-material supply device that supplies a powdered metal material.

What is claimed is:

1. An additive manufacturing apparatus comprising:
a conductive stage arranged in a vacuum chamber;
a conductive base plate arranged on a top side of the stage;
a metal-material supply device that supplies a metal material onto a top side of the base plate;
an electron beam gun that irradiates, with an electron beam, the metal material supplied by the metal-material supply device, and melts and solidifies the metal material;
a grounding circuit that grounds the stage and the base plate; and
a controller that controls the metal-material supply device and the electron beam gun, wherein
the additive manufacturing apparatus includes a resistance heating element that is arranged between the stage and the base plate, and generates heat by a current produced by electron-beam emission from the electron beam gun.

2. The additive manufacturing apparatus according to claim 1, further comprising:
a temperature sensor that senses a temperature of the base plate, wherein
the grounding circuit includes
a first connection wire connected to the stage,
a second connection wire connected to the base plate,
a ground wire, and
a switch that selects one of the first connection wire and the second connection wire, and connects the selected one to the ground wire, and
in a case where the temperature of the base plate sensed by the temperature sensor is lower than a preset predetermined value, the controller controls the switch such that the first connection wire and the ground wire are connected, and in a case where the temperature of the base plate sensed by the temperature sensor is equal to or higher than the predetermined value, the controller controls the switch such that the second connection wire and the ground wire are connected.

3. A method of modifying an additive manufacturing apparatus, the additive manufacturing apparatus including
a conductive stage arranged in a vacuum chamber,
a conductive base plate arranged on a top side of the stage,
a metal-material supply device that supplies a wire-like or powdered metal material onto a top side of the base plate,
an electron beam gun that irradiates, with an electron beam, the metal material supplied by the metal-material supply device, and melts and solidifies the metal material,
a grounding circuit that grounds the stage and the base plate, and
a controller that controls the metal-material supply device and the electron beam gun, wherein
a resistance heating element that generates heat by a current produced by electron-beam emission from the electron beam gun is provided between the stage and the base plate.

4. The method of modifying the additive manufacturing apparatus according to claim 3, wherein
a temperature sensor that senses a temperature of the base plate is provided,
the grounding circuit includes
a first connection wire connected to the stage,
a second connection wire connected to the base plate,
a ground wire, and
a switch that selects one of the first connection wire and the second connection wire, and connects the selected one to the ground wire, and
a function of controlling the switch such that the first connection wire and the ground wire are connected in a case where the temperature of the base plate sensed by the temperature sensor is lower than a preset predetermined value, and of controlling the switch such that the second connection wire and the ground wire are connected in a case where the temperature of the base plate sensed by the temperature sensor is equal to or higher than the predetermined value is added to the controller.
